(19) United States
(12) Patent Application Publication
(10) Pub. No.: US 2013/0323566 A1
(43) Pub. Date: Dec. 5, 2013

(54) THIN SECONDARY BATTERY

(71) Applicants: Takaharu Morikawa, Osaka (JP); Yasushi Nakagiri, Tokushima (JP); Yukishige Inaba, Tokushima (JP); Atsuo Yoneda, Tokushima (JP); Sanae Chiba, Osaka (JP); Koshin Hosoki, Tokushima (JP)

(72) Inventors: Takaharu Morikawa, Osaka (JP); Yasushi Nakagiri, Tokushima (JP); Yukishige Inaba, Tokushima (JP); Atsuo Yoneda, Tokushima (JP); Sanae Chiba, Osaka (JP); Koshin Hosoki, Tokushima (JP)

(73) Assignee: PANASONIC CORPORATION, Osaka (JP)

(21) Appl. No.: 13/985,502

(22) PCT Filed: Apr. 11, 2012
(86) PCT No.: PCT/JP2012/002508

§ 371 Date: Aug. 14, 2013

(30) Foreign Application Priority Data
Aug. 22, 2011 (JP) 2011-180147

(51) Int. Cl. H01M 10/04

(52) U.S. Cl. CPC H01M 10/0436
USPC 429/127

(57) ABSTRACT

A thin secondary battery with a power-generating element 10 including positive electrode sheets 12 and negative electrode sheets 14 stacked with separators 5 interposed therebetween, wherein the outermost positive electrode sheet 12 of the power-generating element 10 includes a first resin layer 6a, instead of a positive electrode active material layer 1, on an outer surface of a positive electrode current collector 2, the outermost negative electrode sheet 14 of the power-generating element 10 includes a second resin layer 6b, instead of a negative electrode active material layer 3, on an outer surface of a negative electrode current collector 3, and the first and second resin layers 6a and 6b cover the power-generating element 10, and are bonded to each other at peripheral portions 9 surrounding the power-generating element 10, thereby hermetically sealing the power-generating element 10.

### TECHNICAL FIELD

The present disclosure relates to thin secondary batteries.

### BACKGROUND ART

In recent years, there has been an increasing demand for small and lightweight secondary batteries with high energy density as power sources for driving portable electronic devices.

In addition, progress in upsizing and slimming down of electronic devices has led to an increasing demand for upsizing and slimming down of secondary batteries.

To meet these demands, thin secondary batteries which have, instead of a metal can package formed in a cylindrical shape or a prism shape, a metal laminate package have been developed. The thin secondary batteries with the metal laminate package are flexible, and accordingly, can be installed along not only flat spaces but also curved spaces in electronic devices, for example.

FIG. 9 illustrates the configuration of a thin secondary battery with a conventional metal laminate package. A power-generating element 101 is formed by winding a positive electrode sheet 103 and a negative electrode sheet 102 with a separator 104 interposed therebetween. The positive electrode sheet 103 includes a positive electrode current collector 112 with a positive electrode active material layer 111 formed thereon. The negative electrode sheet 102 includes a negative electrode current collector 122 with a negative electrode active material layer 121 formed thereon. This thin secondary battery is produced by accommodating the power-generating element 101 to which external terminals 105 are connected in a metal laminate package 110 together with an electrolyte.

Normally, the metal laminate package is made of metal foil such as aluminum foil having resin layers such as polyethylene layers formed on both surfaces of the metal foil. The resin layers located on the inner side of the metal laminate package are heat-welded at peripheral portions surrounding the power-generating element 101, thereby hermetically sealing the power-generating element 101. Accordingly, the metal foil of the laminate package and the power-generating element are out of electrical contact with each other due to the presence of the resin layers interposed between the metal foil and the power-generating element.

Meanwhile, in a secondary battery with a metal can package, the metal can package is connected to the positive or negative electrode of a power-generating element. Accordingly, the metal can package has a shielding effect against external electrical noise. On the other hand, in a secondary battery with a metal laminate package, resin layers interposed between metal foil of the laminate package and a power-generating element prevent the metal foil and the power-generating element from coming into electrical contact. Accordingly, the metal foil has no shielding effect.

To address this problem, Patent Document 1 describes a method in which metal foil is exposed at a sealing portion of a metal laminate package and caused to come into contact with an external terminal, thereby causing the metal foil to be at the same potential as the external terminals.

Patent Document 2 describes the following method. Part of a resin layer located on the inner side of a metal laminate package is removed to expose metal foil, and the metal foil is caused to come into contact with a positive electrode or a negative electrode. Part of a resin layer located on the outer side of the package is removed to expose the metal foil, and the metal foil is caused to serve as an external terminal.

### CITATION LIST

### Patent Document

PATENT DOCUMENT 1: Japanese Patent Publication No. 2000-353496
PATENT DOCUMENT 2: Japanese Patent Publication No. 2004-31272

### SUMMARY OF THE INVENTION

### Technical Problem

In a secondary battery with a metal can package, the metal can package is in contact with a power-generating element. Thus, the secondary battery with the metal can package has a structure in which heat generated by the power-generating element is easily absorbed by the metal can package and dissipated to the outside.

On the other hand, in a secondary battery with a metal laminate package, resin layers having a low thermal conductivity are interposed between metal foil and a power-generating element. Thus, the secondary battery with the metal laminate package has a structure in which heat generated by the power-generating element is not easily dissipated to the outside. Therefore, the whole secondary battery is likely to be heated to a high temperature if the power-generating element generates an unusual amount of heat.

Although the secondary batteries described in Patent Documents 1 and 2 are each configured such that the metal foil of the laminate package is electrically connected to the power-generating element, it is difficult to dissipate heat generated inside the batteries to the outside with a high degree of efficiency because these batteries also include the resin layers interposed between the metal foil and the power-generating element.

It is therefore a principal object of the present disclosure to provide a thin secondary battery which is capable of dissipating heat generated inside the battery with a high degree of efficiency, and has an improved energy density.

### Solution to the Problem

A thin secondary battery of the present disclosure includes a power-generating element including a positive electrode sheet having a positive electrode current collector and positive electrode active material layers formed on both surfaces of the positive electrode current collector and a negative electrode sheet having a negative electrode current collector and negative electrode active material layers formed on both surfaces of the negative electrode current collector, in which the positive electrode sheet and the negative electrode sheet are stacked together with a separator interposed therebetween, wherein the outermost positive electrode sheet of the power-generating element includes a first resin layer, instead of the positive electrode active material layer, on an outer surface of the positive electrode current collector, the outermost negative electrode sheet of the power-generating element includes a second resin layer, instead of the negative electrode active material layer, on an outer surface of the negative electrode current collector, and the first resin layer and the second resin layer cover the power-generating element, and are bonded to each other at peripheral portions of the first and second resin layers surrounding the power-generating element, thereby hermetically sealing the power-generating element.

According to the present disclosure, in the outermost positive electrode sheet and the outermost negative electrode sheet, only the resin layers that hermitically seal the power-generating element are present on the outer surfaces of the electrode current collectors. Consequently, heat generated inside the battery is directly dissipated from the outermost current collectors to the outside through the resin layers, and a heat-dissipating effect can be improved. In addition, since the power-generating element is hermitically sealed only with the resin layers formed on the current collectors included in the outermost positive and negative electrode sheets, it is possible to increase the energy density of the battery of the present disclosure in comparison with the secondary batteries sealed with the conventional metal laminate packages.

### Advantages of the Invention

According to the present disclosure, heat generated inside the battery can be dissipated with a high degree of efficiency, and a thin secondary battery having an improved energy density can be provided.

### BRIEF DESCRIPTION OF THE DRAWINGS

FIG. 1 is an exploded perspective view illustrating a configuration of a power-generating element included in a thin secondary battery according to an embodiment of the present disclosure.

FIG. 2(a)-(d) are cross-sectional views illustrating configurations of stacked positive electrode sheets and negative electrode sheets.

FIG. 3 is a cross-sectional view illustrating a configuration of the thin secondary battery according to the embodiment of the present disclosure.

FIG. 4 is a plan view illustrating the configuration of the thin secondary battery according to the embodiment of the present disclosure.

FIG. 5 is an exploded perspective view of a power-generating element according to a variation of the present disclosure.

FIG. 6 is a cross-sectional view of a thin secondary battery according to the variation of the present disclosure.

FIG. 7 is an exploded perspective view of a power-generating element according to another variation of the present disclosure.

FIG. 8 is a cross-sectional view of a thin secondary battery according to another variation of the present disclosure.

FIG. 9 illustrates the structure of a thin secondary battery with a conventional metal laminate package.

### DESCRIPTION OF EMBODIMENTS

An embodiment of the present disclosure will be described below in detail with reference to the drawings. Note that the present disclosure is not limited to the embodiment below. Further, alterations may be appropriately made as long as such alterations do not cause deviation from the scope in which the advantages of the present disclosure are obtained. Furthermore, the embodiment may be combined with other embodiments.

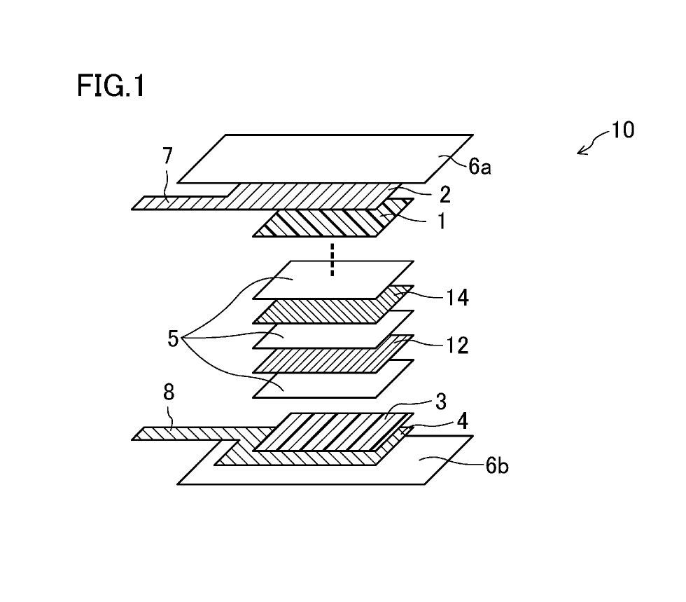

FIG. 1 is an exploded perspective view illustrating a configuration of a power-generating element 10 included in a thin secondary battery according to an embodiment of the present disclosure.

As illustrated in FIG. 1, the power-generating element 10 includes positive electrode sheets 12 and negative electrode sheets 14 which are stacked together with separators 5 interposed therebetween.

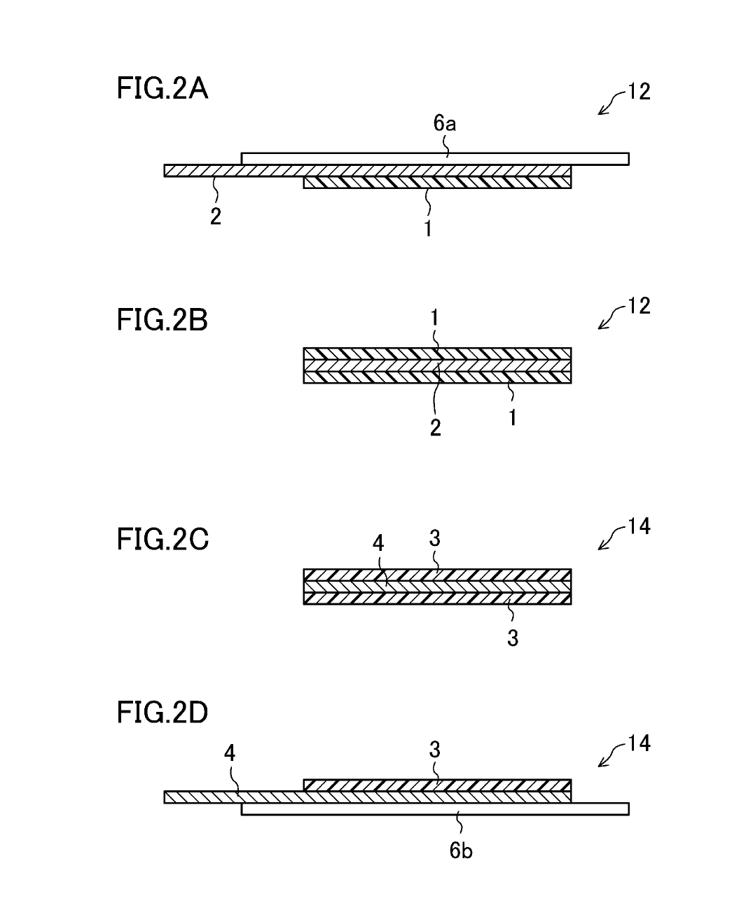

FIG. 2 illustrates cross sections of the stacked positive electrode sheets 12 and negative electrode sheets 14. FIG. 2(a) is a cross-sectional view of the outermost one of the positive electrode sheets 12. FIG. 2(b) is a cross-sectional view of one of the positive electrode sheets 12 which are not located outermost. FIG. 2(c) is a cross-sectional view of one of the negative electrode sheets 14 which are not located outermost. FIG. 2(d) is a cross-sectional view of the outermost one of the negative electrode sheets 14.

As illustrated in FIG. 2(b), each of the positive electrode sheets 12 which are not located outermost includes a positive electrode current collector 2 and positive electrode active material layers 1 formed on both surfaces of the positive electrode current collector 2. As illustrated in FIG. 2(c), each of the negative electrode sheets 14 which are not located outermost includes a negative electrode current collector 4 and negative electrode active material layers 3 formed on both surfaces of the negative electrode current collector 4.

As illustrated in FIG. 2(a), the outermost positive electrode sheet 12 includes a first resin layer 6a which is formed, instead of the positive electrode active material layer 1, on the outer surface the positive electrode current collector 2. As illustrated in FIG. 2(d), the outermost negative electrode sheet 14 includes a second resin layer 6b which is formed, instead of the negative electrode active material layer 3, on the outer surface of the negative electrode current collector 4. The first resin layer 6a and the second resin layer 6b are formed in such a manner that the layers 6a and 6b cover the entirety of the outer surface of the positive electrode current collector 2 and the entirety of the outer surface of the negative electrode current collector 4, respectively.

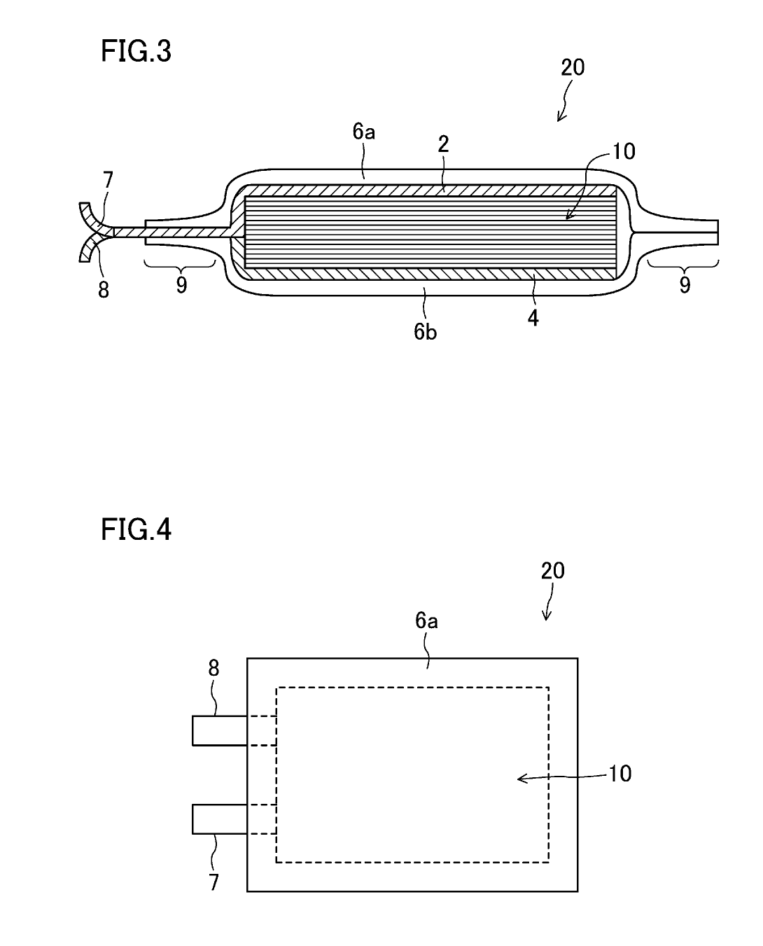

FIG. 3 is a cross-sectional view illustrating a configuration of a thin secondary battery 20 of this embodiment. FIG. 4 is a plan view of the thin secondary battery 20.

As illustrated in FIGS. 3 and 4, the first resin layer 6a and the second resin layer 6b cover the power-generating element 10, and are bonded to each other at their peripheral portions 9 (sealing portions 9) which surround the power-generating element 10, thereby hermetically sealing the power-generating element 10.

In this embodiment, the positive electrode current collector 2 of the outermost positive electrode sheet 12 and the negative electrode current collector 4 of the outermost negative electrode sheet 14 respectively include external terminals 7 and 8 extending outward from the peripheral portions 9 of the first and second resin layers 6a and 6b.

In the outermost positive electrode sheet 12 and the outermost negative electrode sheet 14 included in the power-generating element 10 of the present disclosure, only the first resin layer 6a and the second resin layer 6b that hermitically seal the power-generating element 10 are present on the outer surfaces of the positive electrode current collector 2 and the negative electrode current collector 4. Here, the positive electrode current collector 2 and the negative electrode current collector 4 are respectively in contact with the first resin layer 6a and the second resin layer 6b over a large area, and the thickness of each of the first resin layer 6a and the second resin layer 6b is very small relative to the associated contact area. Consequently, heat generated inside the battery is transmitted, with a very high degree of efficiency, to the outside from the outermost positive electrode current collector 2 and the outermost negative electrode current collector 4 through the first resin layer 6a and the second resin layer 6b. Thus, the thin secondary battery 20 of this embodiment is capable of dissipating heat generated inside the battery to the outside with a high degree of efficiency.

The power-generating element 10 of the present disclosure is sealed only with the first resin layer 6a formed on the outer surface of the positive electrode current collector 2 included in the outermost positive electrode sheet 12 and the second resin layer 6b formed on the outer surface of the negative electrode current collector 4 included in the outermost negative electrode sheet 14. In other words, the present disclosure is configured such that the outermost positive electrode sheet 12 and the outermost negative electrode sheet 14 apparently replace the conventional metal laminate package.

The conventional metal laminate package is made of metal foil having resin layers formed on both surfaces of the metal foil, and the resin layers located on the inner side of the metal laminate package are heat-welded at their peripheral portions surrounding a power-generating element, thereby hermetically sealing the power-generating element. Here, the metal foil serves as a base material of the package, and at the same time, has a function of preventing air and moisture from entering the battery from the outside. The resin layers have a function of maintaining the strength of the metal foil and a function of hermetically sealing the power-generating element by sealing the periphery of the metal laminate package.

In the outermost positive electrode sheet 12 and the outermost negative electrode sheet 14 of the present disclosure, the positive electrode current collector 2 and the negative electrode current collector 4 correspond to the metal foil of the metal laminate package, and accordingly, have the function of preventing air and moisture from entering the battery from the outside. In addition, since the positive electrode current collector 2 and the negative electrode current collector 4 themselves have a positive potential and a negative potential, the current collectors 2 and 4 have a shielding effect. Further, since each of the positive electrode current collector 2 and the negative electrode current collector 4 typically has a thickness of 10-20 μm, the current collectors 2 and 4 also have flexibility.

On the other hand, the first resin layer 6a and the second resin layer 6b of the present disclosure, which are formed on the outer surfaces of the positive electrode current collector 2 and the negative electrode current collector 4, have a function of maintaining the strength of the positive electrode current collector 2 and the negative electrode current collector 4, and a function of hermetically sealing the power-generating element 10 by being sealed at the peripheral portions 9 surrounding the power-generating element 10.

Thus, the outermost positive electrode sheet 12 and the outermost negative electrode sheet 14 of the present disclosure have both of the function as a power-generating element and the functions that the conventional metal laminate package has. Accordingly, the secondary battery 20 of the present disclosure has a configuration in which the outermost positive electrode sheet 12 and the outermost negative electrode sheet 14 are substantially added as a further part of the power-generating element, as compared to the secondary battery hermetically sealed with the conventional metal laminate package. With this configuration of the present disclosure, it is possible to obtain a thin secondary battery with an improved energy density.

In the present disclosure, materials for the positive electrode current collectors 2, the negative electrode current collectors 4, the first resin layer 6a, and the second resin layer 6b are not particularly limited.

For example, aluminum, aluminum alloys, stainless steel, titanium, or titanium alloys may be used to form the positive electrode current collectors 2. For example, copper, copper alloys, nickel, nickel alloys, stainless steel, aluminum, or aluminum alloys may be used to form the negative electrode current collectors 4. Each of the positive electrode current collectors 2 and the negative electrode current collectors 4 preferably has a thickness of 5-100 μm.

Each of the first resin layer 6a and the second resin layer 6b may be made of, for example, polyethylene, polypropylene, polyamide, polyimide, polytetrafluoroethylene (PTFE) resin, polyvinylidene difluoride (PVDF) resin, modified polypropylene, polyvinyl acetate, or nylon resin. Each of the first resin layer 6a and the second resin layer 6b preferably has a thickness of 10-100 μm. If the resin layers 6a and 6b had a thickness smaller than 10 μm, it would be difficult to maintain the strength of the positive electrode current collector 2 and the negative electrode current collector 4. If the resin layers 6a and 6b had a thickness larger than 100 μm, heat-dissipating effects would be reduced.

In the present disclosure, methods for forming the first resin layer 6a and the second resin layer 6b on the outer surfaces of the positive electrode current collector 2 and the negative electrode current collector 4 are not particularly limited. For example, the first and second resin layers 6a and 6b may be respectively bonded, by means of an adhesive, to the outer surfaces of the positive electrode current collector 2 and the negative electrode current collector 4. In this case, resin sheets which have been formed in advance may be used as the first resin layer 6a and the second resin layer 6b. Alternatively, the first resin layer 6a and the second resin layer 6b may each be formed by applying a semi-molten resin to the outer surface of the positive electrode current collector 2 and the outer surface of the negative electrode current collector 4.

In the present disclosure, the first resin layer 6a and the second resin layer 6b are bonded to each other at the peripheral portions 9 (the sealing portions 9) surrounding the power-generating element 10, and thereby hermetically seal the power-generating element 10. This bonding may be implemented by, e.g., melting the first resin layer 6a and the second resin layer 6b and sticking the layers to each other. In this case, each of the first resin layer 6a and the second resin layer 6b is preferably made of a resin material which melts at a temperature of 100-200° C. For example, polypropylene, polyethylene, or polyester may be used as the resin material. It is also possible to form the resin layers 6a and 6b without using the resin materials as exemplified above while separately providing a hot-melt resin which melts at a temperature of 100-200° C. on the inner surfaces of the peripheral portions 9 of the first and second resin layers 6a and 6b. For example, polyethylene, polypropylene, or polyester may be used as the hot-melt resin. If the power-generating element includes the external terminals 7 and 8 extending outward from the peripheral portions 9 of the resin layers 6a and 6b, it is effective to separately provide the hot-melt resin on the peripheral portions 9 because the hot-melt resin overlapping the external terminals 7 and 8 melts to fill gaps between the first resin layer 6a, the second resin layer 6b, the external terminal 7, and the external terminal 8. In this manner, adhesion properties of the sealing portions between which the external terminals 7 and 8 are interposed can be further improved.

In the outermost positive electrode sheet 12 and the outermost negative electrode sheet 14, the positive electrode active material layer 1 on the inner surface of the positive electrode current collector 2 and the negative electrode active material layer 3 on the inner surface of the negative electrode current collector 4 can be formed by using ordinary methods for forming a positive electrode sheet and a negative electrode sheet.

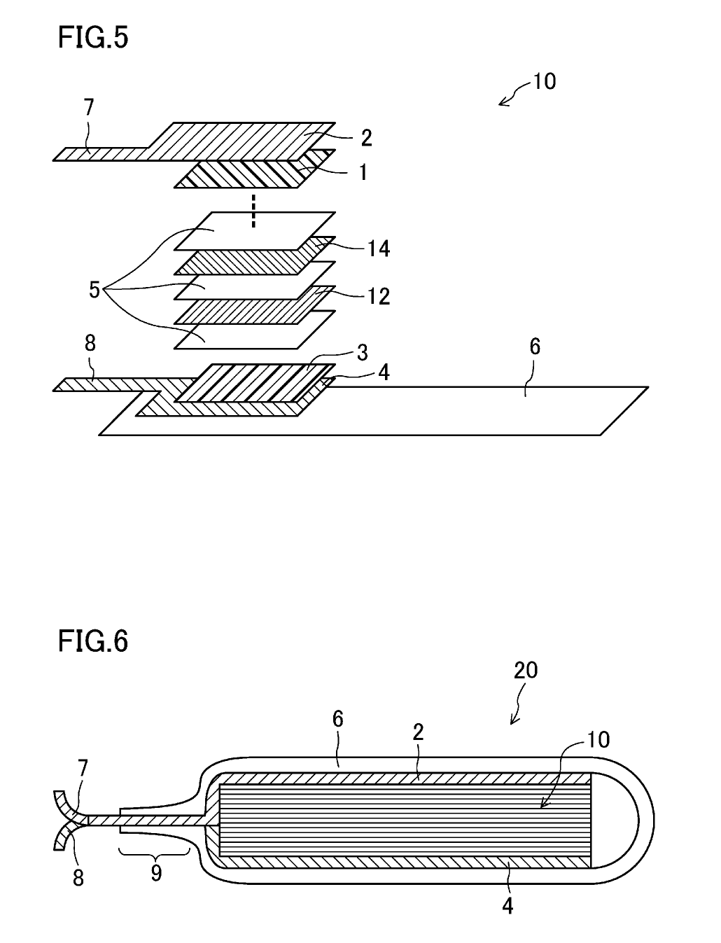

FIG. 5 is an exploded perspective view illustrating a configuration of a power-generating element 10 according to a variation of this embodiment. FIG. 6 is a cross-sectional view of a thin secondary battery 20 including the power-generating element 10 illustrated in FIG. 5. In this variation, the first and second resin layers 6a and 6b are integrally made of a continuous resin layer 6.

As illustrated in FIG. 5, the resin layer 6 is formed on the outer surface of any one of the outermost positive electrode sheet 12 or the outermost negative electrode sheet 14 (in this variation, the outermost negative electrode sheet 14). The resin layer 6 is about twice as long as the electrode sheet on which the resin layer is formed. In this case, no resin layer 6 is formed on the outer surface of the other outermost electrode sheet (in this variation, the outermost positive electrode sheet 12).

As illustrated in FIG. 6, the thin secondary battery 20 of this variation is formed by bending the resin layer 6 formed on the outer surface of the negative electrode sheet 14 in such a manner that the resin layer 6 covers the entirety of the power-generating element 10, and then by bonding overlapping end regions (sealing portions 9) of the resin layer 6 to each other. According to this variation, the area of the sealing portions can be reduced, and a secondary battery with a higher degree of hermetical sealing can be obtained.

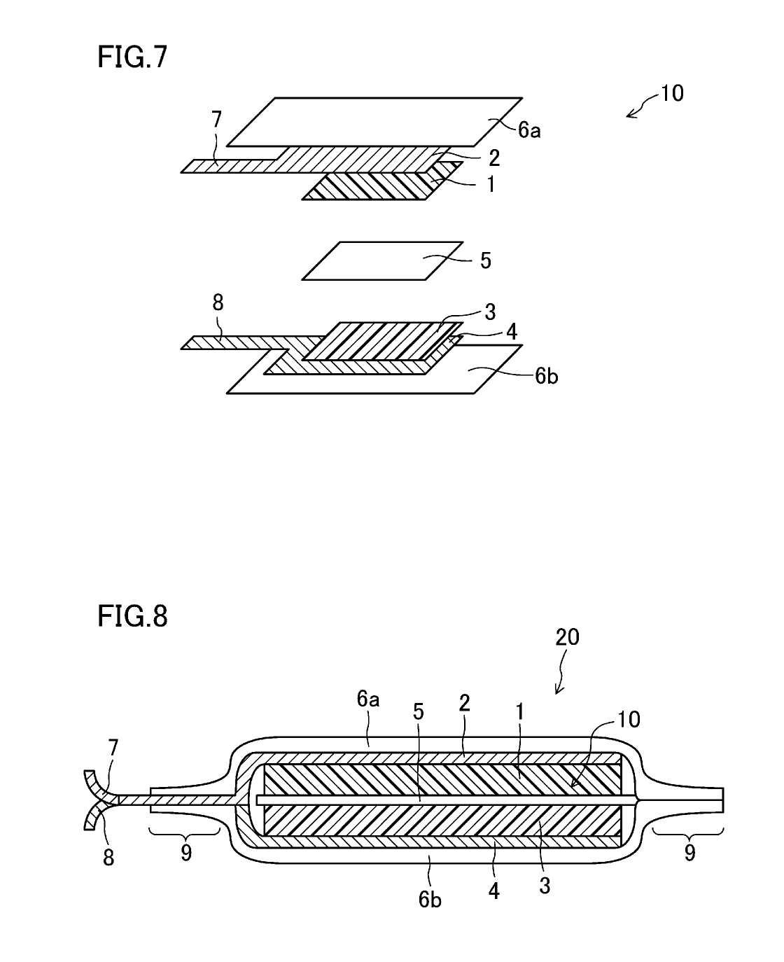

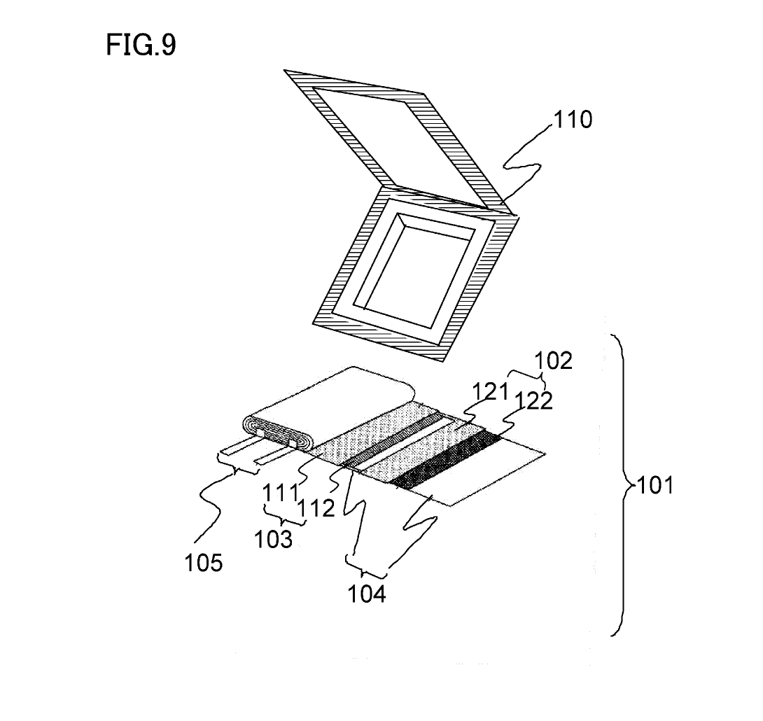

FIG. 7 is an exploded perspective view illustrating a configuration of a power-generating element 10 according to another variation of this embodiment. FIG. 8 is a cross-sectional view of a thin secondary battery 20 including the power-generating element 10 illustrated in FIG. 7.

As illustrated in FIG. 7, the power-generating element 10 of this variation has two-layer structure in which a positive electrode sheet 12 and a negative electrode sheet 14 are stacked together with a separator 5 interposed therebetween. In this case, a positive electrode active material layer 1 is formed on the inner surface of a positive electrode current collector 2 whereas a first resin layer 6a is formed on the outer surface of the positive electrode current collector 2, and a negative electrode active material layer 3 is formed on the inner surface of a negative electrode current collector 4 whereas a second resin layer 6b is formed on the outer surface of the negative electrode current collector 4.

As illustrated in FIG. 8, in the thin secondary battery 20 of this variation, the first resin layer 6a and the second resin layer 6b cover the power-generating element 10, and are bonded to each other at their peripheral portions 9 (sealing portions 9) which surround the power-generating element 10, and thereby hermetically sealing the power-generating element 10. In this variation, the positive electrode current collector 2 of the positive electrode sheet 12 and the negative electrode current collector 4 of the negative electrode sheet 14 respectively have external terminals 7 and 8 extending outward from the peripheral portions 9 of the first and second resin layers 6a and 6b.

The present disclosure has been described above with reference to the preferable embodiment. The above description is not intended to limit the scope of the present disclosure, and various alterations may be made, as a matter of course. For example, although the above embodiment exemplifies the outermost positive electrode current collector 2 and the outermost negative electrode current collector 4 that have the external terminals 7 and 8 extending outward from the peripheral portions of the first and second resin layers 6a and 6b, the external terminals 7 and 8 may be omitted.

Further, when the power-generating element 10 has, as illustrated in FIG. 1, a multilayer structure in which a plurality of the positive electrode sheets 12 and a plurality of the negative electrode sheets 14 are stacked together with separators 5 each interposed between the positive electrode sheet 12 and the negative electrode sheet 14 adjacent to each other, the positive electrode sheets 12 and the negative electrode sheets 14 may be electrically parallel-connected to one another. In this manner, thin secondary batteries varying in thickness or capacity can be easily produced.

Furthermore, although the above embodiment exemplifies the power-generating element 10 made by stacking the positive electrode sheets 12 and the negative electrode sheets 14 with the separators 5 interposed therebetween, the power-generating element 10 may be made by winding the positive electrode sheet 12 and the negative electrode sheet 14 with the separator 5 interposed therebetween. In this case, part of the outer surface of the current collector that is located on the outermost circumference of the power-generating element is exposed. A resin layer is formed on the exposed part such that the resin layer covers the power-generating element, and a peripheral portion of the resin layer surrounding the power-generating element is sealed. In this manner, a thin secondary battery can be produced.

The secondary battery according to the present disclosure is not limited to a particular type, and a lithium ion battery or a nickel hydrogen battery may be used for example. In this case, materials for a positive electrode active material, a negative electrode active material, a separator, an electrolyte, and other components may be appropriately selected according to the type of a battery and a capability which the battery is required to have.

### INDUSTRIAL APPLICABILITY

The thin secondary batteries of the present disclosure are useful as power sources for driving, e.g., electronic devices, automobiles, and electric motorcycles.

### DESCRIPTION OF REFERENCE CHARACTERS

1 Positive electrode active material layer
2 Positive electrode current collector
3 Negative electrode active material layer
4 Negative electrode current collector
5 Separator
6a First resin layer
6b Second resin layer
7, 8 External terminal
9 Peripheral portions (Sealing portions)
10 Power-generating element
12 Positive electrode sheet
14 Negative electrode sheet
20 Thin secondary battery

1. A thin secondary battery comprising a power-generating element including a plurality of positive electrode sheets each having a positive electrode current collector and positive electrode active material layers formed on both surfaces of the positive electrode current collector and a plurality of negative electrode sheets each having a negative electrode current collector and negative electrode active material layers formed on both surfaces of the negative electrode current collector, the positive electrode sheet and the negative electrode sheet stacked together with a separator interposed therebetween,
Wherein
the positive electrode sheets and the negative electrode sheets are electrically parallel-connected to one another,
the outermost positive electrode sheet of the power-generating element includes a first resin layer, instead of the positive electrode active material layer, on an outer surface of the positive electrode current collector,
the outermost negative electrode sheet of the power-generating element includes a second resin layer, instead of the negative electrode active material layer, on an outer surface of the negative electrode current collector, and
the first resin layer and the second resin layer cover the power-generating element, and are bonded to each other at peripheral portions of the first and second resin layers surrounding the power-generating element, thereby hermetically sealing the power-generating element.

2. The thin secondary battery of claim 1, wherein
each of the positive electrode current collector of the outermost positive electrode sheet and the negative electrode current collector of the outermost negative electrode sheet includes an external terminal extending outward from peripheral portions of the first and second resin layers.

3. The thin secondary battery of claim 1, wherein
each of the first and second resin layers includes hot-melt resin provided on the peripheral portion surrounding the power-generating element, and the first and second resin layers are bonded to each other by heat-welding the hot-melt resin.

4. The thin secondary battery of claim 1, wherein
the first and second resin layers are integrally made of a continuous resin layer.

5. (canceled)

6. The thin secondary battery of claim 1, wherein
each of the first and second resin layers is made of at least one selected from the group consisting of polyethylene, polypropylene, polyamide, polyimide, polytetrafluoroethylene resin, polyvinylidene difluoride resin, modified polypropylene, polyvinyl acetate, and nylon.

7. (canceled)
